(19) United States
(12) Patent Application Publication
(10) Pub. No.: US 2012/0278198 A1
(43) Pub. Date: Nov. 1, 2012

(54) EFFICIENT CHOICE SELECTION FOR MULTI-ELEMENT PRODUCTS

(76) Inventors: Ronald Steven Cok, Rochester, NY (US); Pauline Tello, Concord, CA (US)

(21) Appl. No.: 13/093,882

(22) Filed: Apr. 26, 2011

(51) Int. Cl. G06Q 30/00

(52) U.S. Cl. 705/26.5

(57) ABSTRACT

A method for efficiently specifying a plurality of product specifications includes providing product element specifications having multiple selection choices for product elements, presenting user-interactive pages to select a choice for each product element, receiving a selected choice for each product element to specify a first product specification, presenting a last user-interactive page following the user-interactive pages, the last user-interactive page including a user-interactive graphic element that when selected presents a repeated one of the user-interactive pages, receiving a selected choice for the product element corresponding to the repeated user-interactive page in a second product specification that is different from the product element selection choice in the first product specification, and automatically selecting unspecified product element choices in the second product specification that are the same as in the first product specification, thereby producing a second product specification different from the first product specification.

### FIELD OF THE INVENTION

The present invention relates to user interface design, and more particularly to efficiently selecting from among multiple choices for multiple product elements of multiple products.

### BACKGROUND OF THE INVENTION

Products that include images are a popular keepsake or gift for many people. Such image products typically include one or more pictures taken by an individual that is inserted into, or is otherwise a part of, another product to enhance the product, the presentation of the image, or to provide storage for the image. Examples of such image products include picture albums, posters, picture calendars, picture mugs, picture ornaments, picture mouse pads, and picture post cards.

Many such image products include a variety of product elements that are part of the image product. Each of the product elements can have a variety of optional choices and a selection of the optional choices made for each product element that is part of the image product. For example, an image print can be made in a variety of sizes, in a variety of arrangements, with various artistic enhancements such as templates or mattes, and on a variety of photographic papers. In another example, photo-books can have a variety of sizes, page materials, backgrounds, and cover types. In such cases, a customer should not only select one or more images, but should also select the other elements of the image product, for example the matte, the frame, the arrangement of the image(s), the size, or the photographic paper type. Some of the elements or element choices available to a customer will depend on the selection of other elements or choices, for example a matte or frame of a particular size can complement an image print of a corresponding size or color. Selection from among the many choices and product elements of an image product can be tedious and error prone, particularly for multiple versions of the same product.

In computer-based, on-line shopping environments, for example, in web-based businesses such as the Kodak Gallery, users interact with client computers that are connected through the internet to remote server computers. The server computers provide information presented in graphic user interfaces to the remote client computers. The information is often specified in hypertext markup language (html) that defines pages in the world-wide web and is useful for responding to user operations to make product selections and specify any related product elements and choices. Images of sample products can be shown to the user in the graphic user interfaces to aid selection as well as views of sample products incorporating user images. Once the user selects the appropriate product, provides the desired image(s), and specifies the various attributes associated with the selected product and image(s), the product information can be sent to an image fulfillment system and the product manufactured, for example, as described in U.S. Pat. Nos. 6,370,280 and 6,147,742.

Because graphic user information is provided from a remote computer through a computer network, user interface responsiveness is an important concern. It can take a perceptible time for a user to navigate from one page to the next, particularly if large amounts of data, such as images, are communicated between the server computer and the client computer. Furthermore, multiple display pages are often employed that are confusing and make it difficult for a user to visualize and compare the desired product, product elements, product attributes, or product options. It is therefore difficult for the user to make selections.

There is a need, therefore, for user interface designs, computer systems, and methods that enable a user to efficiently select products and product elements in a computing environment.

### SUMMARY OF THE INVENTION

In accordance with the present invention, there is provided a method for efficiently specifying a plurality of product specifications, comprising:

a) providing a specification specifying a plurality of product elements, each product element having multiple selection choices for the product element, the selected choice for each of the product elements specifying a product specification;

b) using a processor to present a sequential plurality of user-interactive pages in a graphic user interface, each user-interactive page corresponding to a product element to select a choice for each product element, and each user-interactive page presenting the multiple selection choices for a corresponding product element in a product specification;

c) using the processor to receive a selected choice for each product element to specify a first product specification;

d) using the processor to present a last user-interactive page following the sequential plurality of user-interactive pages, the last user-interactive page including a user-interactive graphic element that when selected presents a repeated one of the sequential plurality of user-interactive pages;

e) using the processor to receive a selected choice for the product element corresponding to the repeated user-interactive page in a second product specification that is different from the product element selection choice in the first product specification; and

f) using the processor to automatically select unspecified product element choices in the second product specification that are the same as in the first product specification, thereby producing a second product specification different from the first product specification.

The present invention provides for an efficient selection of multiple product elements' product choices for product specifications in a graphic user interface of a computing environment. The number of user interactions is reduced and repeated selections of the same choices are not necessary.

These and other attributes of the present invention will be better appreciated and understood when considered in conjunction with the following description and the accompanying drawings. It should be understood, however, that the following description, although indicating embodiments of the present invention and numerous specific details thereof, is given by way of illustration and not of limitation. For example, the summary descriptions above are not meant to describe individual, separate embodiments whose elements are not interchangeable. Many of the elements described as related to a particular embodiment can be used together with and interchanged with, elements of other described embodiments. The figures below are not intended to be drawn to any precise scale with respect to relative size, angular relationship, or relative position or to any combinational relationship with respect to interchangeability, substitution, or representation of an actual implementation.

### BRIEF DESCRIPTION OF THE DRAWINGS

The above and other features and advantages of the present invention will become more apparent when taken in conjunction with the following description and drawings wherein identical reference numerals have been used to designate identical features that are common to the figures, and wherein:

FIG. 1 is a flow diagram according to an embodiment of the present invention;

FIG. 2 is a flow diagram according to an alternative embodiment of the present invention;

FIG. 3A illustrates a user-interactive page for selecting image choices useful in embodiments of the present invention;

FIG. 3B illustrates a user-interactive page for selecting template choices useful in embodiments of the present invention;

FIG. 3C illustrates a user-interactive page for selecting frame choices useful in embodiments of the present invention;

FIG. 3D illustrates a last user-interactive page useful in embodiments of the present invention;

FIG. 3E illustrates a user-interactive page-selection page useful in embodiments of the present invention;

FIG. 3F illustrates an alternative last user-interactive page useful in embodiments of the present invention;

FIGS. 4A-4C illustrate five different flow diagrams useful in understanding various embodiments of the present invention;

FIG. 5 is a schematic of a system useful in various embodiments of the present invention;

FIG. 6 is an illustration of an embodiment of a computer system useful in various embodiments of the present invention;

FIG. 7 is an illustration of an embodiment of a desktop computer, work station, or kiosk that can be used in a system of FIG. 6;

FIG. 8 is an illustration of an embodiment of a mobile communication device that can be used in a system of FIG. 6; and

FIG. 9 is an illustration of an embodiment of a product specification useful in various embodiments of the present invention.

### DETAILED DESCRIPTION OF THE INVENTION

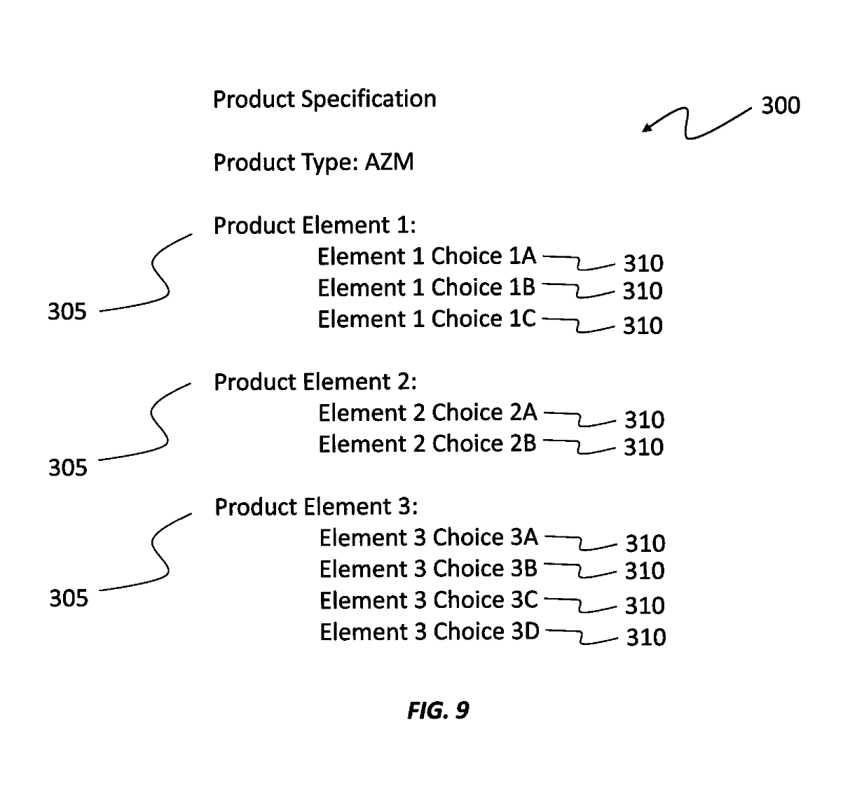

According to the present invention, an image product is a product that includes a user's personalized images incorporated into an image-related object, such as for example a photo-book, a picture greeting card, a picture mug, or other image-related product. As illustrated in FIG. 9, an image product can be specified with a specification 300 having product elements 305 that each have a variety of product element choices 310 that can be selected. Different products will have different specifications 300 with different product element 305 and selectable element choices 310. For example, a framed print of an image or picture, with or without a template or matte, forms an image-related product that can be specified. The images can be positioned in specified, pre-determined locations or can be adaptively positioned according to the sizes, attribute ratios, orientations and other attributes of the images or image-related product. Likewise, the image sizes, orientations, or attributes included in the image product can be adjusted, either to accommodate pre-defined templates with specific pre-determined openings or adaptively adjusted for inclusion in an image product. For example, an image selected by a user can be cropped, reduced in size, or enlarged, either automatically according to an algorithm or manually by the user. Although the description below is addressed to image products by way of illustration, the present invention is not limited to image products and can be applied to any product having multiple product elements and choices for which multiple product versions are desired.

Image products can be interactively specified on a computer terminal, for example on a remote client computer connected through the internet to a server computer. The server computer can provide web pages in the world-wide web (for example specified in hypertext markup language) that are communicated to the remote client computer and presented to a user. The user then interacts with the web pages to make appropriate selections and specify an image product specification. The selections are communicated to the server and the specified product is made and delivered or communicated to a product manufacturer for manufacture and delivery to a designated recipient.

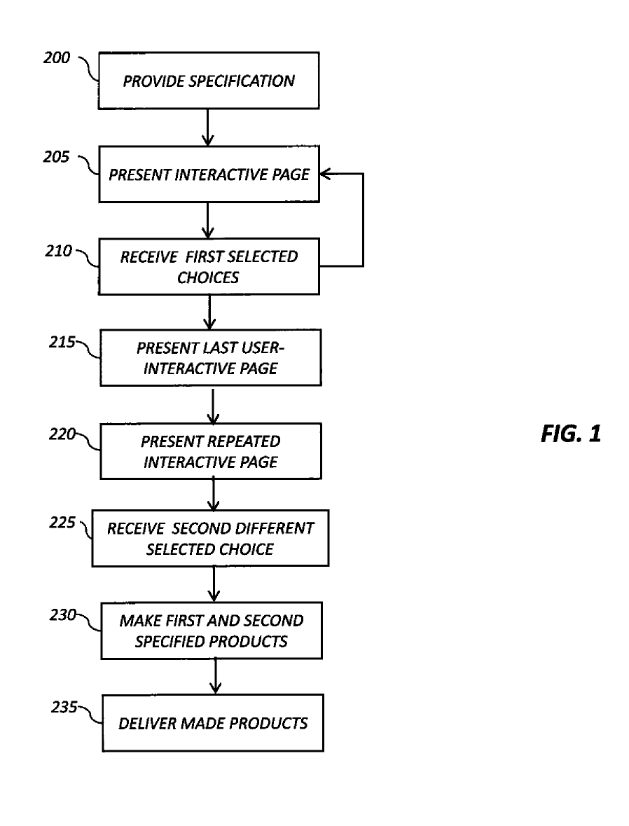

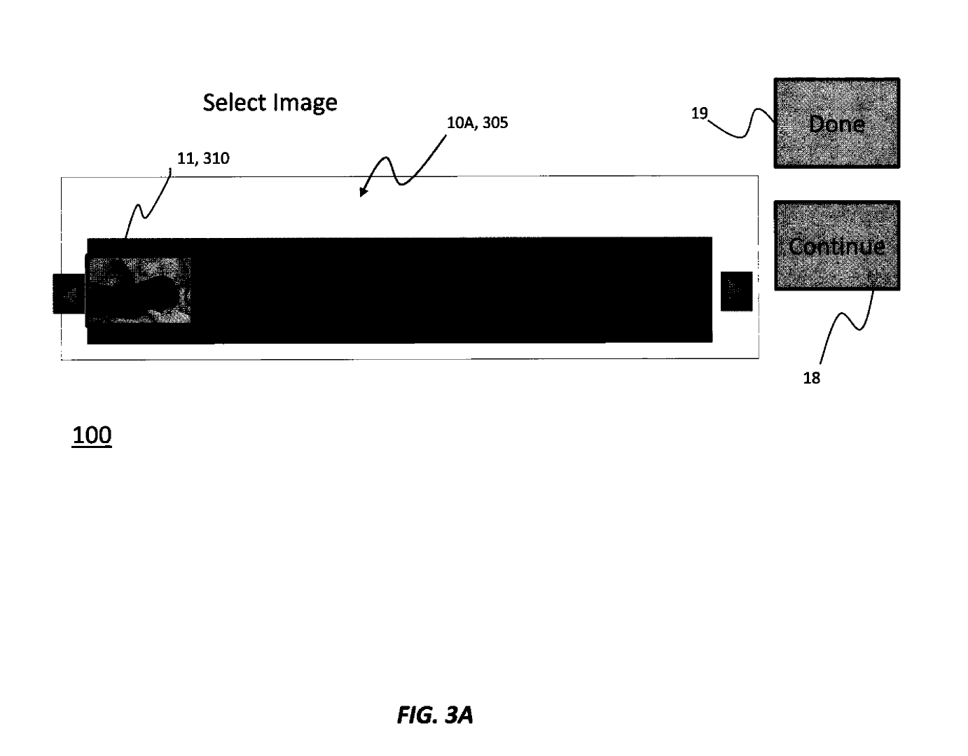

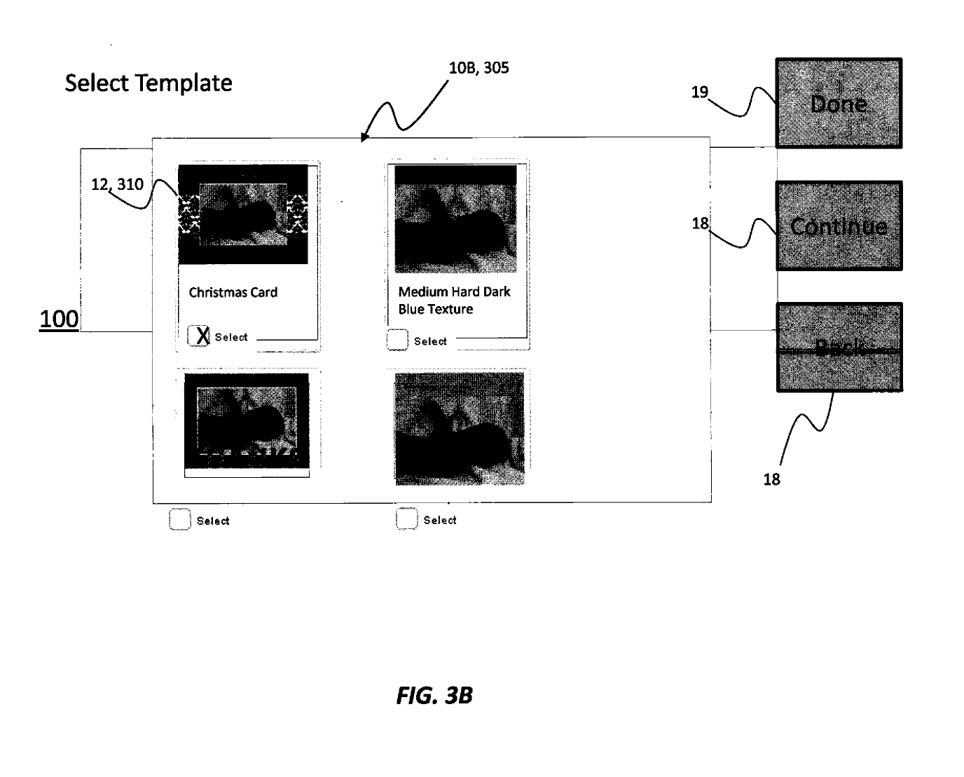

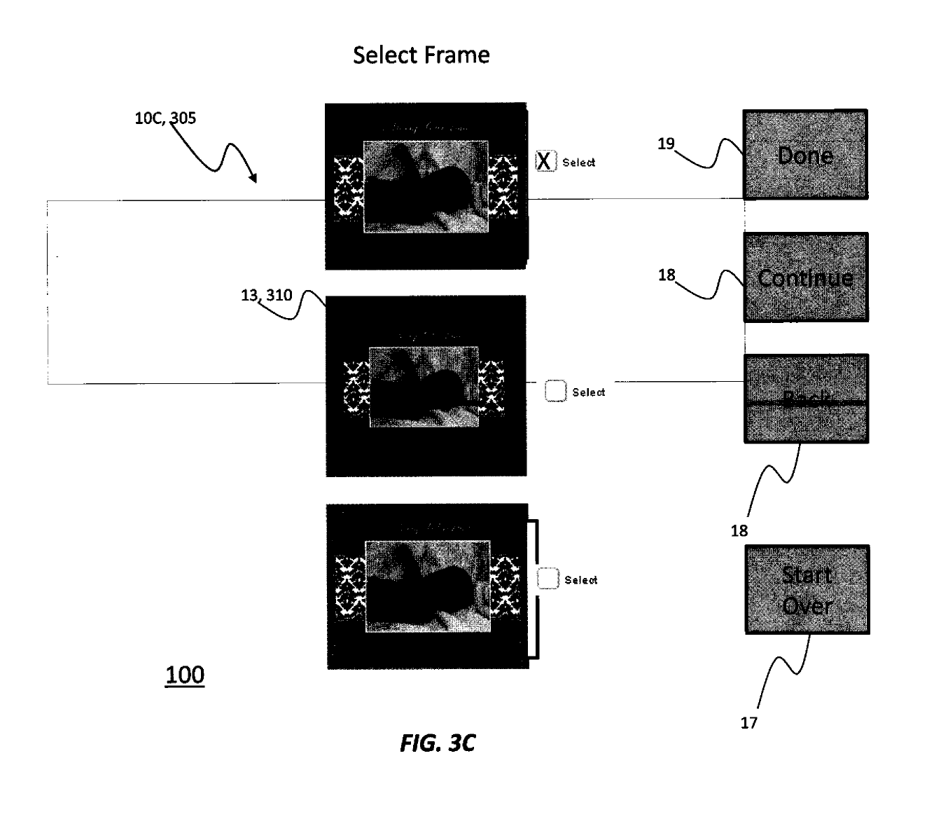

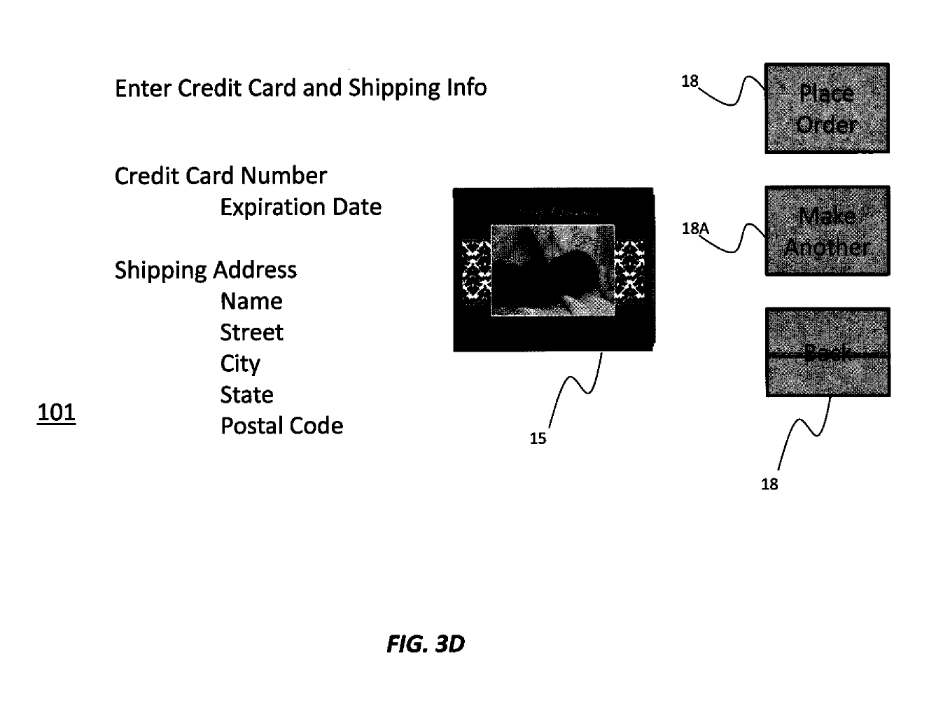

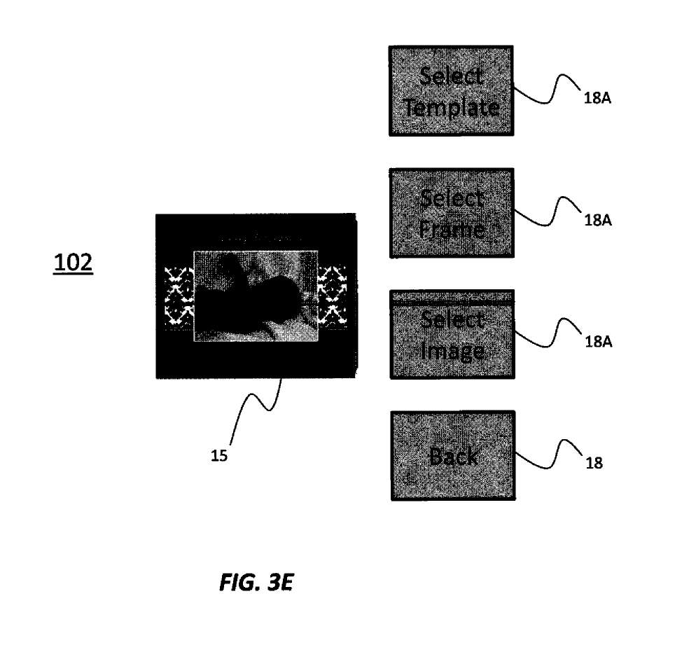

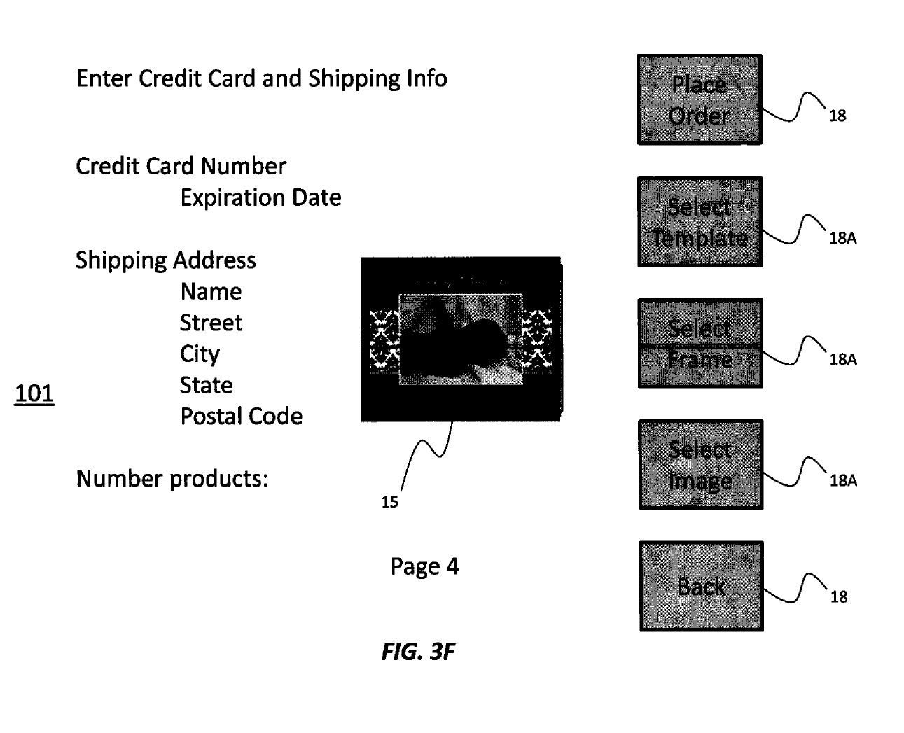

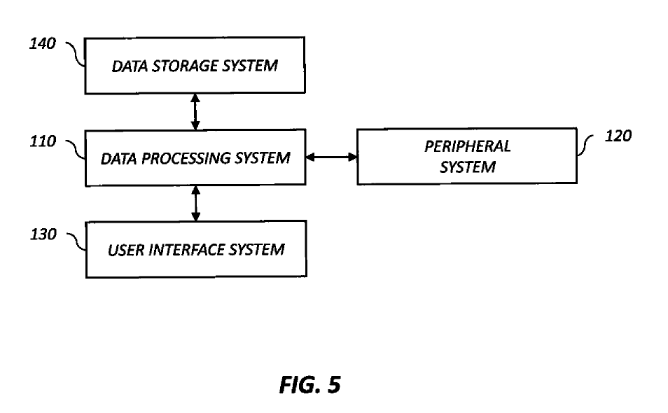

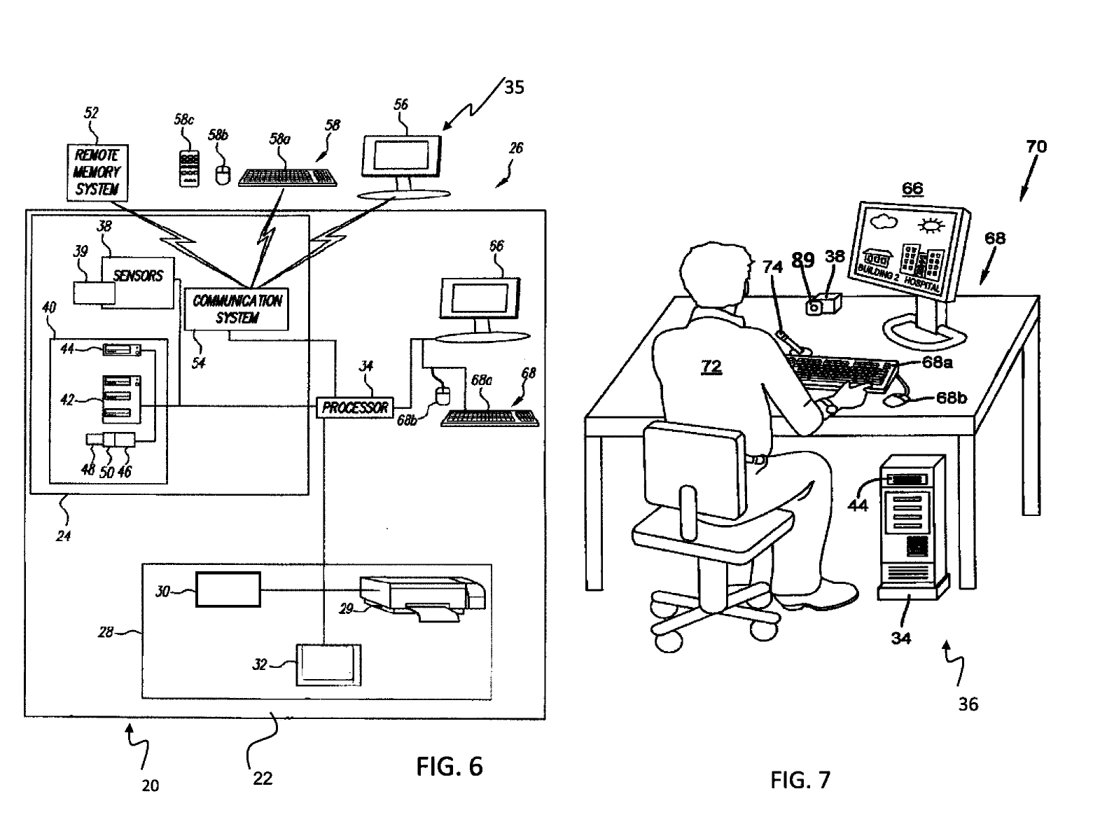

It is important to efficiently and intuitively present image product options to a user to enable efficient and effective choices in the process of making appropriate selections and image product specifications. Referring to FIG. 1 and also to FIGS. 5, 6 7, and 9 in an embodiment of the present invention, a method for efficiently specifying a plurality of product specifications 300 includes providing a specification (step 200) specifying a plurality of product elements 305, each product element 305 having multiple selection choices for a product element (hereinafter element choices) 310 for the product element 305, the selected element choice 310 for each of the product elements 305 specifying a product specification 300 and using a processor 34 (FIG. 6) to present a sequential plurality of user-interactive pages 100 (illustrated in FIGS. 3A-3C below) in a graphic user interface (step 205), each user-interactive page 100 corresponding to a product element 305 to select an element choice 310 for each product element 305, and each user-interactive page 100 presenting the multiple selection element choices 310 for a corresponding product element 305 in a product specification 300. The processor 34 (FIG. 6) is used to receive a selected element choice 310 for each product element 305 to specify a first product specification (step 210). Each user-interactive page 100 is sequentially presented and an element choice 310 selected for each corresponding product element 305. The processor 34 (FIG. 6) presents a last user-interactive page 101 (FIG. 3D) following the sequential plurality of user-interactive pages 100 (step 215), the last user-interactive page 101 including a user-interactive graphic element 18A (FIG. 3D) that when selected presents a repeated one of the sequential plurality of user-interactive pages 100 (step 220), and receives a selected element choice 310 (step 225) for the product element 305 corresponding to the repeated user-interactive page 100 in a second product specification 300 that is different from the selected product element choice 310 in the first product specification 300 and automatically selecting unspecified product element choices 310 in the second product specification 300 to be the same as in the first product specification 300, thereby producing a second product specification 300 different from the first product specification 300. In step 230, the specified first and second products are made. Alternatively and according to an embodiment of the present invention, the first and second specified products are communicated to a product manufacturer to be made. The manufactured products are delivered to one or more recipients (step 235).

In an embodiment of the present invention, the processor 34 (FIG. 6) can be used to present in the last user-interactive page 101 an element choice 310 for a product element 305 in a product specification 300, for example in a manner similar to that used in the plurality of user-interactive pages 100. Alternatively, the last user-interactive page 101 can request other useful information, such as information for specifying, making, purchasing, or delivering a product.

As shown in FIG. 9, the specification 300 can take a variety of forms, for example an xml (extended markup language) file can be used to provide and store a reference to an image product, corresponding product element 305, and the product element choices 310. Other ways known in the art can be used in the present invention, such as the use of multiple files or different file types, as are known in the computing arts. Once the product element choices 310 are selected, the selected element choices 310 can be entered into the specification 300 to specify the product specification 300. Multiple selected product element choices 310 can be included or referenced in the product specification 300. For example a product specification file can reference other files that themselves include a list of the selected product element choices 310.

The user-interactive graphic element 18A (FIG. 3D) can be an icon representing a repeated user-interactive page 100 or the element choices 310 available on the user-interactive page 100 and can be used to enable navigation to the repeated user-interactive page 100 corresponding to the different element choices 310. By selecting the icon in the graphic user interface, the repeated user-interactive page 100 can be presented. For example, an html hot spot can be defined spatially corresponding to the icon location in the user-interactive page 100 to provide a way to navigate to the repeated user-interactive page 100.

The present invention provides a useful method for specifying multiple products that share product element choices 310. The multiple products can be of the same type. In such a case, it is not efficient for a user to re-specify common product element choices 310 in different products. Instead, according to the present invention, only the selected product element choices 310 that are different between multiple different products need be specified. Hence, the present invention provides a method for simplifying element choices 310 in a product specification 300 and for making the element choices 310 more efficiently in less time.

According to an embodiment of the present invention, the first and second product specifications 300 can have different element choices 310 for more than one different product element 305. In this embodiment, the processor 34 (FIG. 6) is used to present repeated two or more of the sequential plurality of user-interactive pages 100 and receive an element choice 310 for each of the repeated user-interactive pages 100 presented to specify the second product specification 300.

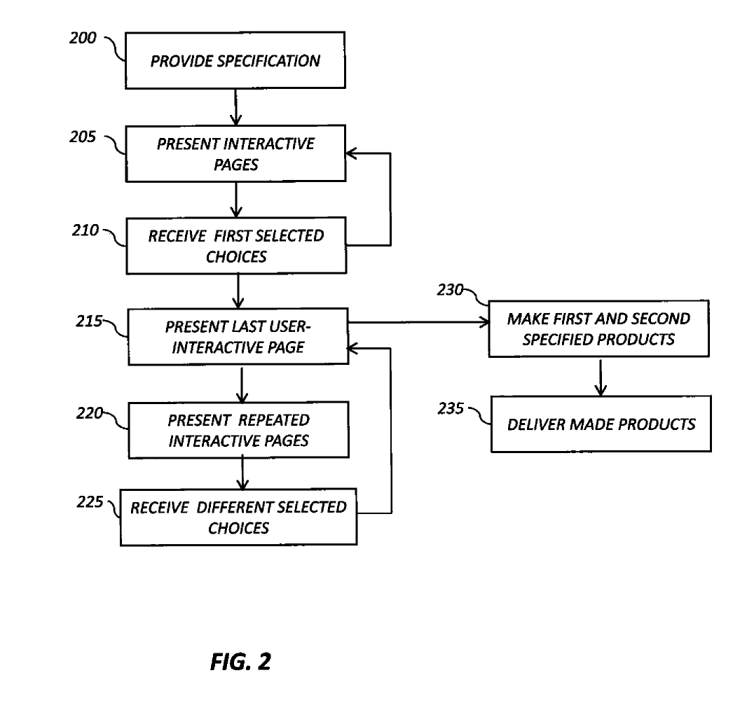

In another embodiment of the present invention, after making the different second product specification choice selection (step 225), the last user-interactive page 100 is re-presented (thereby repeating step 215 for the second product specification 300 as illustrated in FIG. 2). Additional repeated user-interactive pages 100 can then be re-presented (step 220) and second different element choices 310 (step 225) specified for each of the product elements 305 corresponding to the repeated user-interactive pages 100. When all of the different product element selection choices 310 are specified, the first and second product specifications 300 can be used to make the specified products (step 230).

The method illustrated in FIG. 2 can be iteratively repeated for multiple product specifications 300. By repeating the steps 215, 220, and 225, different element choices 310 can be made for various product elements 305 in multiple product specifications. Thus, the processor 34 (FIG. 6) can be used to iteratively and repeatedly specify different product specifications 300, each different product specification 300 having at least one product element choice 310 selection in common with the other different product specifications 300 and each different product specification 300 having at least one product element choice selection 310 different from the other different product specifications 300.

To efficiently enable the selection of multiple different product element choices 310 for multiple different product specifications 300, multiple user-interactive icons can be provided on the last user-interactive page 101 that when selected, present corresponding repeated user-interactive pages 100. By selecting a desired icon (e.g. 18A, FIG. 3D), for example with a mouse cursor in the graphic user interface, the corresponding repeated user-interactive page 100 can be presented and a different element choice 310 for the corresponding product element 305 specified. Alternatively, the user-interactive graphic element 18A (FIG. 3D) presents a user-interactive product-element-selection page that enables the selection of one of the plurality of user-interactive pages (FIG. 3E described below).

Referring to FIGS. 3A-3F, in an example of an embodiment of the present invention, a processor 34 (FIG. 6) presents user-interactive pages 100. The user-interactive pages 100 can be presented in a browser on a computer (e.g. using information provided by a remote server connected to the computer through a computer network such as the internet). Alternatively, the computer can execute software provided on a stand-alone computer to present the user-interactive pages 100.

In the example of FIGS. 3A-3F, the desired product is a printed image with a template in a frame. (As used herein, a template is a graphically-enhanced matte or image surround designed to complement the image and frame to provide a more aesthetically pleasing image product.) The specification 300 then includes the three product elements 305 of an image, a template, and a frame. For each of the three product elements 305, a plurality of element choices 310 is made available for selection in a user-interactive page 100. Although the example illustrated in FIGS. 3A-3F is a specific image product, with specific product elements 305 and element choices 310, the present invention is not limited to this specific example. For example, selected product element choices 310 can include product type, product color, template, matte, or image.

In the example of FIGS. 3A-3F, the first user-interactive page 100 in the sequential plurality of user-interactive pages 100 is illustrated in FIG. 3A. The second user-interactive page 100 in the sequential plurality of user-interactive pages 100 is illustrated in FIG. 3B. The third user-interactive page 100 in the sequential plurality of user-interactive pages 100 is illustrated in FIG. 3C. The last user-interactive page 101 in the sequential plurality of user-interactive pages 100 is illustrated in FIGS. 3D and 3F.

Referring to FIG. 3A, a plurality of image choices 11 are shown as the first product element 10A. A user presented with this user-interactive page 100 can select an image choice 11, using methods known in the user-interface arts, such as highlighting the selected choice or providing a border around the choice. Once the product element choice 11 is selected, a second product element choice 10B (FIG. 3B) can be selected by selecting navigation icon 18 to navigate to a second user-interactive page 100 (FIG. 3B).

Referring to FIG. 3B, a plurality of template choices 12 are shown as the second product element 10B. A user presented with this user-interactive page 100 can select a template choice 12, using methods known in the user-interface arts, such as a check-box (as shown). Once the product element choice 12 is selected, a third product element choice 10C (FIG. 3C) can be selected by selecting navigation icon 18 to navigate to a third user-interactive page 100.

Referring to FIG. 3C, a plurality of frame choices 13 are shown as the third product element 10C. A user presented with this user-interactive page 100 can select a frame choice 13, using methods known in the user-interface arts, such as a check-box (as shown). Once the last frame 13 is selected, a first image product specification 15 is completed (FIGS. 3D, 3F). Purchase information is obtained by selecting navigation icon 18 to navigate to a last user-interactive page 101 (FIG. 3D or 3F).

In each of the user-interactive pages in the sequence of product element choices (FIGS. 3A-3C), one can present the product element choices 310 on the user-interactive page 100 to include the other product element choices 310 that have been selected. For example, in FIG. 3B, the selected image choice 11 (FIG. 3A) is composited into the representations of the template choices 12 (FIG. 3B) to aid the selection of an appropriate template choice 12. Likewise, in FIG. 3C, the selected image and template choices 11 (FIG. 3A) and 12 (FIG. 3B) are composited into the represented frame choices 13 to aid the selection of an appropriate frame choice 13. Likewise, additional navigation icons 18 as are known in the art (e.g. navigation icon 18 for moving back to a previous page) can be provided.

In this example, the last user interactive page 101 (FIGS. 3D and 3F) requests further information (such as financial and shipping information) for the purchase of the specified image product. In other embodiments, the processor 34 (FIG. 6) can present in the last user-interactive page 101 another element choice 310 for a product element 305 in a product specification 300. In any case, according to an embodiment of the present invention, the last user-interactive page 101 includes a user-interactive graphic element 18A that when selected presents a repeated one of the sequential plurality of user-interactive pages 100.

The repeated user-interactive page 100 can be limited to a particular user-interactive page 100. Alternatively, the user-interactive graphic element 18A can present a user-interactive product-element-selection page 102 (FIG. 3E) that enables the selection of a repeated one of the plurality of user-interactive pages 100 by presenting a plurality of navigation icons 18A that each navigate to a corresponding user-interactive page 100. A representation of the image product specification 15 can be included to assist the user. In yet another alternative (FIG. 3F), the last user-interactive page 101 itself can enable the selection of a repeated one of the plurality of user-interactive pages 100, for example by presenting a plurality of navigation icons 18A that each navigate to a corresponding user-interactive page 100. In an embodiment of the present invention, the user-interactive graphic element is an icon representative of the element choice 310 presented on the corresponding user-interactive page 100.

When a repeated user-interactive page 100 is presented, a different selection for the corresponding product element choice 310 can be made to specify a second different product specification 300 that differs from the first product specification 300 only in the different selection made. Once the different product element choice 310 selection is made, navigation icon 19 (FIGS. 3A-3C) presents the last-user interactive page 101 (e.g. FIG. 3D or 3F), or another page can be presented.

The process can be repeated multiple times; each time a different product specification 300 can be created. Hence, the method of the present invention enables fewer product element choice 310 selections to specify a variety of product specifications 300. Thus, according to an embodiment of the present invention, the processor 34 (FIG. 6) is used to repeatedly specify different product specifications 300, each different product specification 300 having at least one product element choice 310 selection in common with the other different product specifications 300 and each different product specification 300 having at least one product element choice 310 selection different from the other different product specifications 300. This increases the efficiency of the process, reduces a user's time spent specifying the variety of product specifications 300, and reduces processing time and network communication (for network-enabled systems).

In an additional embodiment of the present invention, different choice element 310 selections for multiple product elements 305 can be made. For example, rather than selecting the navigation icon 19 that presents the last user-interactive page 101, the next page (or another page) in the sequence of user-interactive pages 100 is presented so that another product element choice 310 can be selected for a different product element 305. Thus, the processor 34 (FIG. 6) can be used to present repeated two or more of the sequential plurality of user-interactive pages 100 and receive a selection for each element choice 310 of the repeated user-interactive pages 100 presented to specify the second product specification 300. The second product specification 300 will differ from the first product specification 300 in multiple product element choices 310.

The navigation icons 19 in the user-interactive pages 100 can be omitted the first time the user-interactive pages 100 are presented so that all of the product elements choices 310 are selected and a complete product specification 300 is specified. Once a user-interactive page 100 is repeated to specify a different product specification 300, the navigation icons 18 can be omitted to limit differences between different product specifications 300 to a single product element. Alternatively, both navigation icons 18 and 19 can be presented to provide greater product element choice 310 selection flexibility. In an embodiment, a navigation icon that presents the first of the sequential plurality of user-interactive pages (e.g. 17 in FIG. 3C) is also included. As used herein, a navigation icon (e.g. 18, 19) presents a user-interactive page 100, for example by enabling software executing on the processor 34 (FIG. 6) to present the corresponding page, e.g. by moving to the appropriate location in a sequence of instructions or requesting a web page. Software methods for using navigation icons to present different pages of information are well-known in the software arts.

In a further embodiment of the present invention, a user-interactive page 100 includes multiple product specifications 300 and corresponding element choices 310.

In another embodiment of the present invention, the method can include adapting to selected element choices 310 for desired product elements 305. In an example, a first product specification 300 is specified as described above, and then a second product specification 300 is specified by selecting a different element choice 310 for a particular product element 305. A third product specification 300 is specified by presenting the user-interactive page 100 corresponding to the different product element choice 310 selection of the second product specification 300. The processor 34 (FIG. 6) is used to present one or more of the sequential plurality of user-interactive pages 100 and the last user-interactive page 101a second time, receiving different second selection element choices 310 to specify a different second product specification 300, comparing the selection choices 310 for the first product specification 300 with the element choices 310 for the different second product specification 300, and then preferentially presenting the user-interactive pages 100 corresponding to the element choices 310 that are different between the first and second product specifications 300.

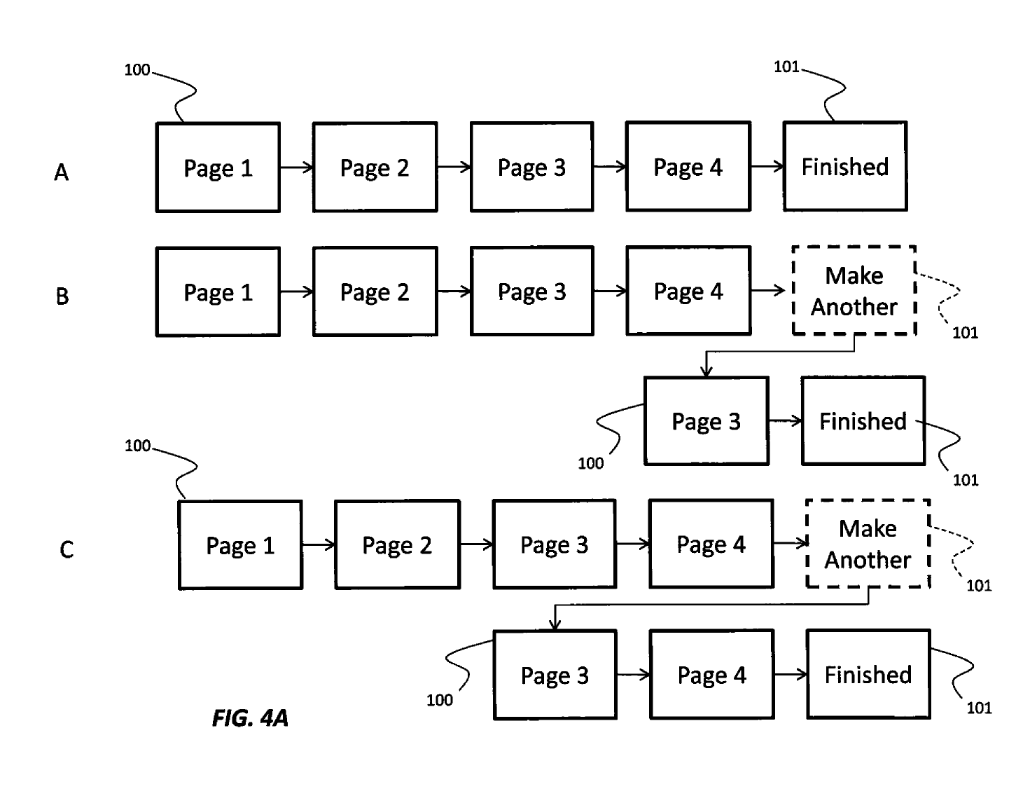

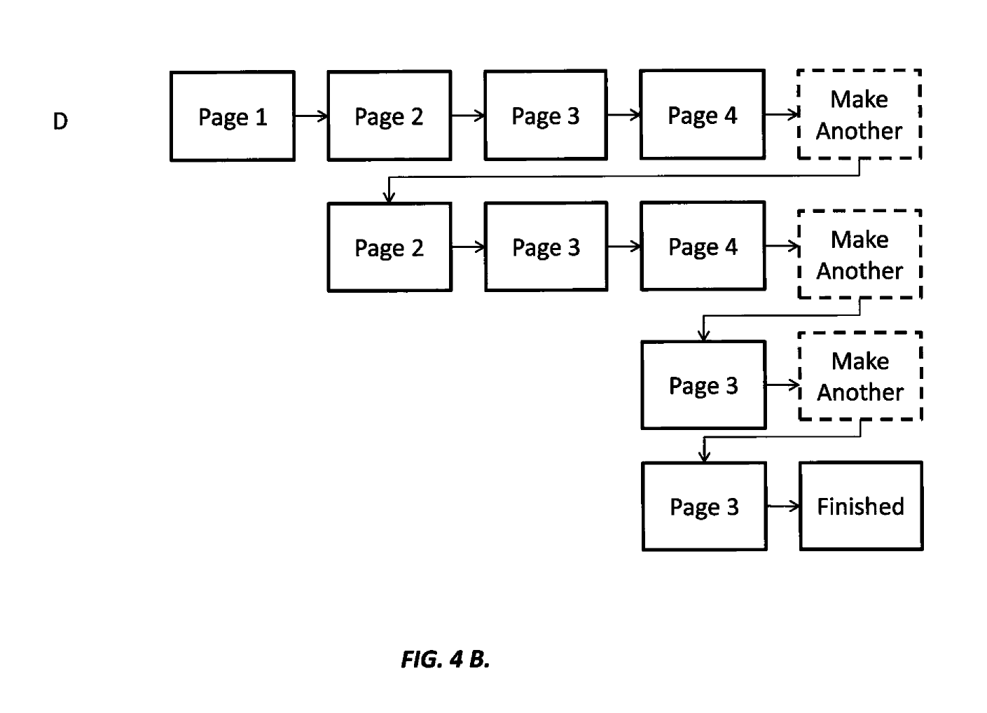

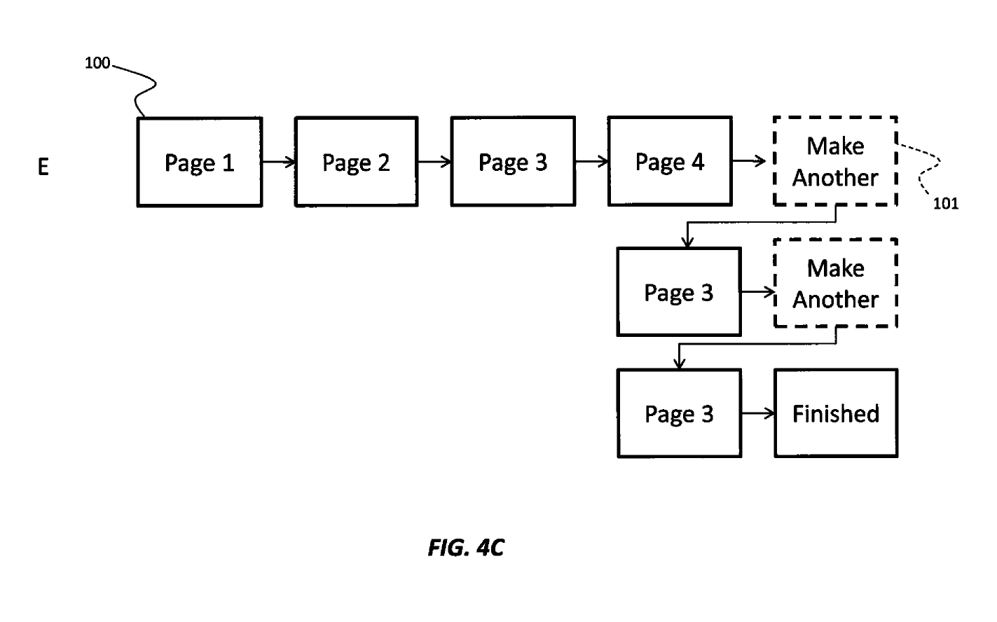

A more general representation of the methods describe above in FIGS. 3A-3F are illustrated in the flow diagrams of FIG. 4A-4C. In FIGS. 4A-4C, a variety of process steps are illustrated in flow graphs A, B, C, D, and E.

Referring to flow graph A in FIG. 4A (and FIG. 9 and FIGS. 3A-3F), at an initial step a user-interactive page 100 is presented for a first product element 305. A product element choice 310 is selected (for example as described with reference to FIG. 3A above) and a second user-interactive page 100 is presented and a second product element choice 310 selection made, followed by presenting third and fourth user-interactive pages 100 with corresponding third and fourth product element choice 310 selections. A last user-interactive page 101 is presented and a product specification 300 is completed. In this example, only one product specification 300 is specified.

Referring to flow graph B of FIG. 4A (and FIG. 9 and FIGS. 3A-3F), rather than ending the process with only one product specification 300, the presentation of user-interactive page 3 is repeated (for example by choosing a navigation icon in the last user-interactive page 100 that presents user-interactive page 3) and a different product element choice 310 for product element 3 is selected. The last user-interactive page 101 is repeated to complete the specification of two different product specifications 300 that differ in their selected element choice 310 for product element 3 and have common selected element choices 310 for product elements 1, 2, and 4.

Referring to flow graph C of FIG. 4A (and FIG. 9 and FIGS. 3A-3F), the presentation of both user-interactive page 3 and user-interactive page 4 are repeated (for example by choosing a navigation icon 19 in the last user-interactive page 100 that presents user-interactive page 3 and then selecting a navigation icon 18 in user-interactive page 3 to present user-interactive page 4). Different product element choices 310 for both the product element of page 3 and the product element of page 4 are selected. The last user-interactive page 101 is repeated to complete the specification of two different product specifications 300 that differ in their selected element choice 310 of both the product element of page 3 and the product element of page 4 and have common selected element choices 310 for the product elements selected on pages 1 and 2.

Referring to flow graph D of FIG. 4B, four different product specifications 300 are specified. After an initial first specification 300, a second product specification 300 is specified by sequentially presenting each of user-interactive pages 2, 3, and 4 (100), and receiving corresponding element choices 310 for each of the corresponding product elements 305. A third product specification 300 is then specified by presenting user-interactive page 3 (100) and receiving the corresponding selection choice 310 for the corresponding product element 305. A fourth product specification 300 is similarly specified. In this example, the second product specification 300 differs from the initial product specification 300 in the selected element choices 310 for the product elements selected on pages 2, 3, and 4 has a common selected element choice 310 for the product element selected on page 1. The third and fourth product specifications 300 differ from the initial product specification 300 in the selected choices 310 for the product element of page 3 and have common selected choices 310 for the product elements selected on pages 1, 2 and 4. Note that the default selection choice 310 for product element 1 is taken from the initial first product specification 300. For the product specifications of pages 3 and 4, the default selection choices for product elements of pages 1 and 2 can be taken from the initial first product specification 300. Alternatively, the default selection element choices 310 for the product elements of pages 1 and 2 can be taken from the most recently made product specification 300 (product specification 2) rather than the initial product specification 300.

Referring to flow graph E of FIG. 4C, an initial first product specification 300 is specified and a second product specification 300 that differs in the selected element choice 310 for the product element selected on page 3 is also specified. In this embodiment, the selected product element of page 3 for the second product specification 300 is chosen for modification from among all of the product elements 305 (e.g. as shown in FIG. 3E or 3F). Based on the second product specification 300 difference, the product element of page 3 for the third product specification 300 is chosen by default to be the product element 305 having a different element choice 310 from the first product specification 300, for example by presenting the third user-interactive page 100 upon the activation of navigation icon 18A on the last user-interactive page 101. Thus, the process flow can adapt to previous element choices 310 made to specify prior product specifications 300.

Referring to FIGS. 5, 6, 7, and 8, a system for efficiently enabling a user 72 to select from a plurality of product element choices 310 to specify a plurality of products includes a processor 34 for generating a plurality of user-interactive pages 100 in a graphic user interface (e.g. shown on local display 66) that includes choices shown to the user 72 for selection. A page can also be considered to be a screen of information presented on a display screen. As intended herein, a page includes information content that is viewable at one moment by the user 72 on one or more displays (e.g. 66). The pages 100 can be presented in a browser on a computer, e.g. using information provided by a remote server connected to the computer through a computer network such as the internet. Alternatively, the computer can execute software provided on a stand-alone computer.

FIG. 5 is a high-level diagram showing the components of a system for efficiently specifying a plurality of product specifications according to an embodiment of the present invention. The system includes a data processing system 110, a peripheral system 120, a user interface system 130, and a data storage system 140. The peripheral system 120, the user interface system 130 and the data storage system 140 are communicatively connected to the data processing system 110.

The data processing system 110 includes one or more data processing devices that implement the processes of the various embodiments of the present invention, including the example processes described herein. The phrases “data processing device” or “data processor” are intended to include any data processing device, such as a central processing unit (“CPU”), a desktop computer, a laptop computer, a mainframe computer, a personal digital assistant, a Blackberry™, a digital camera, a digital picture frame, cellular phone, a smart phone or any other device for processing data, managing data, communicating data, or handling data, whether implemented with electrical, magnetic, optical, biological components, or otherwise.

The data storage system 140 includes one or more processor-accessible memories configured to store information, including the information needed to execute the processes of the various embodiments of the present invention, including the example processes described herein. The data storage system 140 can be a distributed processor-accessible memory system including multiple processor-accessible memories communicatively connected to the data processing system 110 via a plurality of computers or devices. On the other hand, the data storage system 140 need not be a distributed processor-accessible memory system and, consequently, can include one or more processor-accessible memories located within a single data processor or device.

The phrase “processor-accessible memory” is intended to include any processor-accessible data storage device, whether volatile or nonvolatile, electronic, magnetic, optical, or otherwise, including but not limited to, registers, caches, floppy disks, hard disks, Compact Discs, DVDs, flash memories, ROMs, and RAMs.

The phrase “communicatively connected” is intended to include any type of connection, whether wired or wireless, between devices, data processors, or programs in which data can be communicated. The phrase “communicatively connected” is intended to include a connection between devices or programs within a single data processor, a connection between devices or programs located in different data processors, and a connection between devices not located in data processors at all. In this regard, although the data storage system 140 is shown separately from the data processing system 110, one skilled in the art will appreciate that the data storage system 140 can be stored completely or partially within the data processing system 110. Further in this regard, although the peripheral system 120 and the user interface system 130 are shown separately from the data processing system 110, one skilled in the art will appreciate that one or both of such systems can be stored completely or partially within the data processing system 110.

The peripheral system 120 can include one or more devices configured to provide digital content records to the data processing system 110. For example, the peripheral system 120 can include digital still cameras, digital video cameras, cellular phones, smart phones, or other data processors. The data processing system 110, upon receipt of digital content records from a device in the peripheral system 120, can store such digital content records in the data storage system 140.

The user interface system 130 can include a mouse, a keyboard, another computer, or any device or combination of devices from which data is input to the data processing system 110. In this regard, although the peripheral system 120 is shown separately from the user interface system 130, the peripheral system 120 can be included as part of the user interface system 130.

The user interface system 130 also can include a display device, a processor-accessible memory, or any device or combination of devices to which data is output by the data processing system 110. In this regard, if the user interface system 130 includes a processor-accessible memory, such memory can be part of the data storage system 140 even though the user interface system 130 and the data storage system 140 are shown separately in FIG. 5.

As shown in FIG. 6 in more detail and according to another embodiment of the present invention, a computer system for efficiently specifying a plurality of product specifications 300 includes a electronic computer system 20, for example a computer server, connected to a remote electronic computer system 35, for example a remote client computer, through a computer network, the electronic computer system 20 including memory 40 for storing one or more user-interactive pages 100 in a graphic user interface that are communicated through the computer network to the remote electronic computer system 35, the remote electronic computer system 35 having a local display 66 for displaying the user-interactive pages 100 in a graphic user interface.

FIG. 6 illustrates an embodiment of an electronic computer system 20, for example a computer, which can be used in generating an image product specification 300. In the embodiment of FIG. 6, the electronic computer system 20 includes a source of content data files 24, a user input system 26 and an output system 28 connected to the processor 34. The source of content data files 24, user-input system 26 or output system 28 and processor 34 can be positioned within a housing 22 as illustrated. In other embodiments, circuits and systems of the source of content data files 24, user input system 26 or output system 28 can be positioned in whole or in part outside of housing 22.

The source of content data files 24 can include any form of electronic or other circuit or system that can supply digital data to processor 34 from which processor 34 can derive images for use in forming an image-enhanced item. In this regard, the content data files can include, for example and without limitation, still images, image sequences, video graphics, and computer-generated images. Source of content data files 24 can optionally capture images to create content data for use in content data files by use of capture devices located at, or connected to, electronic computer system 20 or can obtain content data files that have been prepared by or using other devices such as the remote electronic computer system 35. In the embodiment of FIG. 6, source of content data files 24 includes sensors 38, the memory 40 and a communication system 54.

Sensors 38 are optional and can include light sensors, biometric sensors and other sensors known in the art that can be used to detect conditions in the environment of electronic computer system 20 and to convert this information into a form that can be used by processor 34 of electronic computer system 20. Sensors 38 can also include one or more image sensors 39 that are adapted to capture still or video images. Sensors 38 can also include biometric or other sensors for measuring involuntary physical and mental reactions such sensors including, but not limited to, voice inflection, body movement, eye movement, pupil dilation, body temperature, and p4000 wave sensors.

Memory 40 can include conventional memory devices including solid-state, magnetic, optical or other data-storage devices. Memory 40 can be fixed within electronic computer system 20 or it can be removable. In the embodiment of FIG. 6, electronic computer system 20 is shown having a hard drive 42, a disk drive 44 for a removable disk such as an optical, magnetic or other disk memory (not shown) and a memory card slot 46 that holds a removable memory 48 such as a removable memory card and has a removable memory interface 50 for communicating with removable memory 48. Data including, but not limited to, control programs, digital images and metadata can also be stored in a remote memory system 52 such as the remote electronic computer system 35, a personal computer, computer network or other digital system. Remote memory system 52 can also include solid-state, magnetic, optical or other data-storage devices.

In the embodiment shown in FIG. 6, electronic computer system 20 has a communication system 54 that in this embodiment can be used to communicate with remote electronic computer systems 35 for example including an optional remote memory system 52, an optional remote display 56, or optional remote input 58 (also referred to herein as “remote input 58”). The optional remote memory system 52, optional remote display 56, and optional remote input 58 can all be part of the remote electronic computer system 35 having a remote input 58 with remote input controls, and that can communicate with communication system 54 wirelessly as illustrated or can communicate in a wired fashion. In an alternative embodiment, a local input station including either or both of the local display 66 and local user input controls 68 (also referred to herein as “local user input 68”) can be connected to communication system 54 using a wired or wireless connection.

Communication system 54 can include for example, one or more optical, radio frequency or other transducer circuits or other systems that convert image and other data into a form that can be conveyed to a remote device such as a remote memory system 52 or a remote display 56 using an optical signal, radio frequency signal or other form of signal. Communication system 54 can also be used to receive a digital image and other data from a host or server computer or network (not shown), the remote memory system 52 or the remote input 58. Communication system 54 provides processor 34 with information and instructions from signals received thereby. Typically, communication system 54 will be adapted to communicate with the remote memory system 52 by way of a communication network such as a conventional telecommunication or data transfer network such as the internet, a cellular, peer-to-peer or other form of mobile telecommunication network, a local communication network such as wired or wireless local area network or any other conventional wired or wireless data transfer system. In one useful embodiment, the electronic computer system 20 can provide web access services to remote electronic computer systems 35 that access the electronic computer system 20 through a web browser. Alternatively, the remote electronic computer system 35 can provide web services to electronic computer system 20 depending on the configurations of the systems.

User input system 26 provides a way for a user 72 of electronic computer system 20 to provide instructions to processor 34. This permits the user 72 to make a designation of content data files to be used in generating an image-enhanced output product and to select an output form for the output product. User input system 26 can also be used for a variety of other purposes including, but not limited to, permitting the user 72 to arrange, organize and edit content data files to be incorporated into the image-enhanced output product, to provide information about the user or audience, to provide annotation data such as voice and text data, to identify characters in the content data files, and to perform such other interactions with electronic computer system 20 as are described herein.

In this regard user input system 26 can include any form of transducer or other device capable of receiving an input from the user 72 and converting this input into a form that can be used by processor 34. For example, user input system 26 can include a touch screen input, a touch pad input, a 4-way switch, a 6-way switch, an 8-way switch, a stylus system, a trackball system, a joystick system, a voice recognition system, a gesture recognition system a keyboard, a remote control or other such systems. In the embodiment shown in FIG. 6, user input system 26 includes an optional remote input 58 including a remote keyboard 58a, a remote mouse 58b, and a remote control 58c and a local user input 68 including a local keyboard 68a and a local mouse 68b.

Remote input 58 can take a variety of forms, including, but not limited to, the remote keyboard 58a, remote mouse 58b or remote control handheld device 58c illustrated in FIG. 6. Similarly, local user input 68 can take a variety of forms. In the embodiment of FIG. 6, local display 66 and local user input 68 are shown directly connected to processor 34.

As is illustrated in FIG. 7 local user input 68 can take the form of an editing area 70 such as a home computer, an editing studio, or kiosk that can also be the remote electronic computer system 35 (not shown) or the electronic computer system 36. In this illustration, the user 72 is seated before a console including local keyboard 68a and mouse 68b and a local display 66 which is capable, for example, of displaying multimedia content, for example in a graphic user interface. As is also illustrated in FIG. 7, editing area 70 can also have sensors 38 including, but not limited to, image sensors 89, audio sensors 74 and other sensors such as multispectral sensors that can monitor user 72 during a production session or provide other information such as images and a storage device such as disk drive 44.

Referring back to FIG. 6 output system 28 is used for rendering images, text or other graphical representations in a manner that permits image-product designs to be combined with user items and converted into an image product. In this regard, output system 28 can include any conventional structure or system that is known for printing or recording images on output device 32 including, but not limited to, printer 29. Printer 29 can record images on a tangible surface 30 using a variety of known technologies including, but not limited to, conventional four-color offset separation printing or other contact printing, silk screening, dry electrophotography such as is used in the NexPress 2100 printer sold by Eastman Kodak Company, Rochester, N.Y., USA, thermal printing technology, drop-on-demand inkjet technology and continuous inkjet technology. For the purpose of the following discussions, printer 29 will be described as a type that generates color images. However, it will be appreciated that this is not necessary and that the claimed methods and apparatuses herein can be practiced with the printer 29 that prints monotone images such as black and white, grayscale, or sepia toned images. As will be readily understood by those skilled in the art, the electronic computer system 20, 36 (FIG. 7) with which the user 72 interacts to define a user-personalized image product can be separated from the remote electronic computer system 35) connected to the printer 29, so that the specification of the image product is remote from its production.

In certain embodiments, the source of content data files 24, user input system 26 and output system 28 can share components.

Processor 34 operates electronic computer system 20 based upon signals from user input system 26, sensors 38, memory 40 and communication system 54. Processor 34 can include, but is not limited to, a programmable digital computer, a programmable microprocessor, a programmable logic processor, a series of electronic circuits, a series of electronic circuits reduced to the form of an integrated circuit, or a series of discrete components.

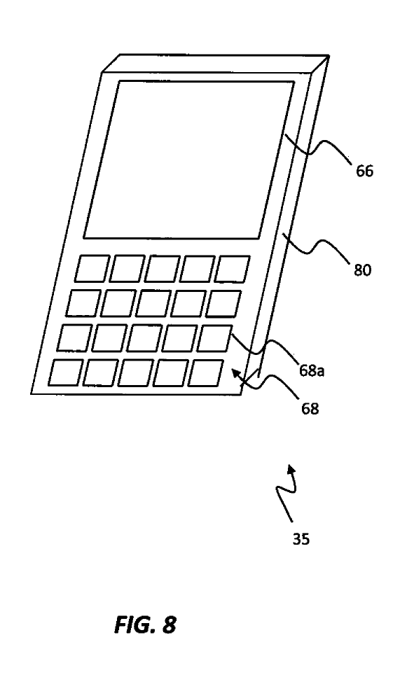

In a useful embodiment of the present invention illustrated in FIG. 8, the remote electronic computer system 35 can be a mobile communication device 80, for example a cellular telephone, a smart phone, or a wirelessly connected hand-held computer such as a tablet computer. The mobile communication device 80 can include a display 66 or a user-input system 26 (not shown) incorporating a local input 68 keyboard 68a. In another embodiment, a local input 68 device can be a touch screen. The mobile communication device 80 can communicate with electronic computer system 20 (not shown) directly, for example through a wireless local area network or a point-to-point wireless connection, or indirectly through a cellular telephony network. The electronic computer system 20 (not shown) can be a computer server, for example providing browser-based web pages to a remote electronic computer system 35, electronic computer system 36 (not shown) and mobile communication device 80.

Any of the server computer 20, remote electronic computer system 35, or the mobile communication device 80 can execute software programs on an internal processor 34. The software programs can interact with the user 72 through a user interface (e.g. local display 66 and local input 68) or with remote computers to accomplish the programmed task. The software programs can execute algorithms to analyze data (e.g. digital image files) or to compute useful values. A computer software program product can include one or more non-transitory, tangible, computer readable storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

In further embodiments of the present invention, the electronic computer system 20 is employed to make the specified products or to enable a third party to make the specified products. Alternatively, the specified products can be made by hand. Once constructed, the specified products can be delivered to the customer or provided to a third party for delivery to the customer.

When used herein, the term displayed image product refers to a representation of an image product shown in the graphic user interface of the display 66 and does not refer to the image product itself. Likewise, a view of an image product or a composited image product is a representation shown in the graphic user interface of the display 66. To select an image product or product element choice 310 or a composited image product or product element choice 310 is to preferentially indicate a representation of the choices shown in the graphic user interface of the display 66. In common usage in the art, to display an image object is understood to mean the same thing as to display a view of the image object, and to select an image object is to preferentially indicate a view of the image object on a display screen. To make the selected composited image product is to physically render, make, assemble, or fabricate it into an object, not to display a view of the composited image product. Likewise, a graphic icon represents a product element, element, attribute, or choice and generally provides a recognizable view of the product element, element, attribute, or choice (e.g. a thumbnail) rather than an abstract representation. A graphic icon, as used herein, can be a thumbnail, a small representation of the product, element, attribute, or choice itself, that is a small image of the product, element, attribute, or choice.

The computer system can include the electronic computer system 20 connected to the remote electronic computer system 35, through a computer network that provides communications between the electronic computer system 20 and the remote electronic computer system 35. In one embodiment of the present invention, the remote electronic computer system 35 includes a browser for rendering web pages and the electronic computer system 20 includes web pages that are provided to the remote electronic computer system 35, through the computer network. Software for selecting a received image from a stored set of user images is employed, in another embodiment. Software for selecting element choices 310 presented in the graphic user interface and for navigating from one user-interactive page 100 to another user-interactive page 100 is provided. Software for purchasing the selected image product, for example provided through electronic internet transaction services, is employed in an embodiment.

As used herein, an image product can be a multi-media product, incorporating multiple different visual and auditory elements, both still and dynamic. According to various embodiments of the present invention, a multi-media product is an image product that includes a user's personalized images incorporated into an image-related object, such as for example a photo-book, a greeting card, a mug, or other image-related product. The images can be still images or image sequences, such as videos, and the multi-media product can include other media features, for example audio tracks, sounds, or sound sequences. A multi-media product can be a hard-copy product, for example a printed image together with an audio playback capability, or an electronic product, for example in an on-line album with still images, multiple still images, image sequences, sounds, a sequence of sounds, or audio tracks, or all of these. For simplicity and clarity of discussion, still images are described herein, but it is to be understood that the methods and objects described can include multi-media products that include images and can be either hard-copy or electronic and that the present invention includes these various embodiments.

The invention has been described in detail with particular reference to certain embodiments thereof, but it will be understood that variations and modifications can be effected within the spirit and scope of the invention.

### PARTS LIST

10A, 10B, 10C product element
11 image choice
12 template choice
13 frame choice
15 image product specification
17 navigation icon
18, 18A navigation icon, user-interactive graphic element
19 navigation icon
20 electronic computer system
22 housing
24 source of content data files
26 user input system
28 output system
29 printer
30 tangible surface
32 output device
34 processor
35 remote electronic computer system
36 electronic computer system
38 sensors
39 image sensors
40 memory
42 hard drive
44 disk drive
46 memory card slot
48 removable memory
50 memory interface
52 remote memory system
54 communication system
56 remote display
58 remote input
58a remote keyboard
58b remote mouse
58c remote control
66 local display
68 local user input controls
68a local keyboard
68b local mouse
70 editing area (home computer, editing studio, or kiosk)
72 user
74 audio sensors
80 mobile communication device
89 image sensor
100 user-interactive page
101 last user-interactive page
102 user-interactive product-element-selection page
110 data processing system
120 peripheral system
130 user interface system
140 data storage system
200 provide specification step
205 present interactive pages step
210 receive selected choices step
215 present last-user-interactive page step
220 present interactive pages step
225 receive different selected choice step
230 make specified products step
235 deliver made product step
300 product specification
305 product element
310 element choice

1. A method for efficiently specifying a plurality of product specifications, comprising:
a) providing a specification specifying a plurality of product elements, each product element having multiple selection choices for the product element, the selected choice for each of the product elements specifying a product specification;
b) using a processor to present a sequential plurality of user-interactive pages in a graphic user interface, each user-interactive page corresponding to a product element to select a choice for each product element, and each user-interactive page presenting the multiple selection choices for a corresponding product element in a product specification;
c) using the processor to receive a selected choice for each product element to specify a first product specification;
d) using the processor to present a last user-interactive page following the sequential plurality of user-interactive pages, the last user-interactive page including a user-interactive graphic element that when selected presents a repeated one of the sequential plurality of user-interactive pages;
e) using the processor to receive a selected choice for the product element corresponding to the repeated user-interactive page in a second product specification that is different from the product element selection choice in the first product specification; and
f) using the processor to automatically select unspecified product element choices in the second product specification that are the same as in the first product specification, thereby producing a second product specification different from the first product specification.

2. The method of claim 1, further including making the first or second specified products or communicating the first or second specified products to a product manufacturer.

3. The method of claim 1, further including using the processor to present in the last user-interactive page a selection choice for a product element in a product specification.

4. The method of claim 1, further including providing a plurality of user-interactive graphic elements on the last user-interactive page that when selected each present a corresponding repeated one of the sequential plurality of user-interactive pages.

5. The method of claim 1, further including using the processor to present repeated two or more of the sequential plurality of user-interactive pages and receive a selection for each choice of the repeated user-interactive pages presented to specify the second product specification.

6. The method of claim 1, further including using the processor to iteratively repeat elements b) through f) to repeatedly specify different product specifications, each different product specification having at least one product element choice selection in common with the other different product specifications and each different product specification having at least one product element choice selection different from the other different product specifications.

7. The method of claim 1, wherein the user-interactive graphic element presents a user-interactive product-element-selection page that enables the selection of one of the plurality of user-interactive pages.

8. The method of claim 1, further including using the processor to present one or more of the sequential plurality of user-interactive pages and the last user-interactive page a second time, receiving different second selection choices to specify a different second product specification, comparing the selection choices for the first product specification with the selection choices for the different second product specification, and then preferentially presenting the user-interactive pages corresponding to the selection choices that are different.

9. The method of claim 1, wherein the user-interactive graphic element is an icon representative of the selection choice presented on the corresponding user-interactive page.

10. The method of claim 1, wherein the product is an image product.

11. The method of claim 1, wherein the selection choices include product type, product color, template, or image.

12. The method of claim 1, further including presenting a user-interactive graphic element on one or more of the sequential plurality of user-interactive pages that presents the previously presented user-interactive pages.

13. The method of claim 1, further including presenting a user-interactive graphic element on one or more of the sequential plurality of user-interactive pages that presents the first of the user-interactive pages.

14. The method of claim 1, further including presenting the product element choices on a user-interactive page with the selected choices of other product elements.

15. A system for efficiently specifying a plurality of product specifications, comprising a processor, a storage device connected to the processor, and communication means for displaying information on a graphic user interface, comprising:
a) the storage device includes a specification specifying a plurality of product elements, each product element having multiple selection choices for the product element, the selected choice for each of the product elements specifying a product specification;
b) the processor presents a sequential plurality of user-interactive pages in a graphic user interface, each user-interactive page corresponding to a product element to select a choice for each product element, and each user-interactive page presenting the multiple selection choices for a corresponding product element in a product specification;
c) the processor receives a selected choice for each product element to specify a first product specification; and
d) the processor presents a last user-interactive page following the sequential plurality of user-interactive pages, the last user-interactive page including a user-interactive graphic element that presents one of the sequential plurality of user-interactive pages to select a choice for the corresponding product element in a second product specification that is different from the product element selection choice in the first product specification; and
e) the processor automatically selects unspecified product element choices in the second product specification that are the same as in the first product specification, thereby producing a second product specification different from the first product specification.

16. The system of claim 15, wherein the processor is a server computer connected to a remote client computer connected to the server computer through a computer network, the server computer communication display information to the remote client computer, the remote client computer receiving the display information and including a display for displaying the received display information on a graphic user interface.
